(19) United States
(12) Patent Application Publication
(10) Pub. No.: US 2020/0337316 A1
(43) Pub. Date: Oct. 29, 2020

(54) VEHICLE-MOUNTED TEMPERATURE-CONTROLLABLE OVEN

(71) Applicant: Zhongshan Yili Electric Appliance Co., Ltd., Zhongshan (CN)

(72) Inventor: Zhichang YANG, Zhongshan (CN)

(21) Appl. No.: 16/539,543

(22) Filed: Aug. 13, 2019

(30) Foreign Application Priority Data
Apr. 28, 2019 (CN) 201920604500.4

(51) Int. Cl. A21B 1/52; A21B 1/02; A21B 3/02; B60N 3/16

(52) U.S. Cl. CPC A21B 1/52; B60N 3/16; A21B 3/02; A21B 1/02

(57) ABSTRACT

A vehicle-mounted temperature-controllable oven comprising an oven body and an insulating partition plate; the insulating partition plate is arranged inside the oven body for dividing the oven body into an upper fuel gas baking chamber and a lower fuel gas baking chamber; a moveable glass cover plate that can be opened upwards is arranged at the top of the oven body; a front door plate that can be opened downwards is arranged at the front end of the oven body, and is hinged with the bottom of the oven body; a fuel gas heating device, a working platform and a baking rack are arranged in the upper fuel gas baking chamber; a control panel is arranged above the front door plate, and the control panel is provided with function knobs and a temperature-control panel for controlling the baking time and temperature, and the opening and closing of the gas path.

### TECHNICAL FIELD OF THE INVENTION

The present invention relates to the technical field of ovens, and more particularly, to a vehicle-mounted temperature-controllable oven.

### BACKGROUND OF THE INVENTION

An electric oven is an electrical appliance that utilizes the heat radiated from the heating element to bake food. It can be used for baking pasta, such as breads, pizzas, egg tarts and cookies.

A fuel gas oven is a direct-fired oven that acts directly on the food by using the heat source. When baking, the food's fat/oil drops immediately. There's no repeated infiltration of the fat/oil, namely, avoiding the frying process. Thus, there's less fat/oil contained in the food, achieving a real baked flavor. However, for fuel gas is used as the heat source, the baked food and the environment can be easily polluted.

With the continuous improvement of people's living standards, self-driving travel has become a lifestyle for many people, and the use of vehicle-mounted oven has become more popular. In the prior art, vehicle-mounted ovens sold on the market are mainly charcoal-fired ovens or solar ovens with simple function. As a result, the food that can be processed in the oven is seriously limited.

### SUMMARY OF THE INVENTION

The purpose of the present invention is to solve the shortcomings in the prior art by providing a vehicle-mounted temperature-controllable oven, wherein the upper portion of the oven body is provided with a chimney cover by which the pollution to the food and air when baking food by using fuel gas can be reduced, and the control panel is provided with a temperature-control panel through which the baking temperature and baking time can be set and controlled, and the opening and closing of the gas path of the gas stove can be controlled, achieving a safe and convenient use.

To achieve the above purpose, the present invention adopts the following technical solution:

A vehicle-mounted temperature-controllable oven comprising an oven body and an insulating partition plate, wherein the insulating partition plate is arranged inside the oven body for dividing the oven body into an upper fuel gas baking chamber and a lower fuel gas baking chamber, wherein a moveable glass cover plate that can be opened upwards is arranged at the top of the oven body, wherein a front door plate that can be opened downwards is arranged at the front end of the oven body, and is hinged with the bottom of the oven body, wherein a fuel gas heating device, a working platform and a baking rack are arranged in the upper fuel gas baking chamber, wherein the upper portion of the fuel gas heating device is covered by the working platform, and the baking rack is erected above the working platform through a supporting frame, wherein a fuel gas heating apparatus is arranged inside the lower fuel gas baking chamber, and a bearing rack and a bearing platform are respectively arranged above and underneath the fuel gas heating apparatus, wherein the movable glass cover plate is connected with a glass supporting plate through a hinge, wherein a chimney trim strip is embedded in the groove of the rear end of the glass supporting plate, and a chimney cover is arranged in the middle of the chimney trim strip, wherein a control panel is arranged above the front door plate, and the control panel is provided with function knobs and a temperature-control panel used for controlling the baking time and the baking temperature.

In another aspect of the present invention, the fuel gas heating device further comprises a fuel gas heater, a gas pipe connected with the fuel gas heater, and a gas solenoid valve installed on the gas pipe for controlling the communication of the fuel gas.

In another preferred embodiment, there're three fuel gas heaters, which are distributed in a triangle-shape.

In another preferred embodiment, the fuel gas heater is fixed on the insulating partition plate.

In another preferred embodiment, the movable glass cover plate comprises a main cover plate and an auxiliary cover plate. One end of the main cover plate and one end of the auxiliary cover plate are hinged with each other.

In another preferred embodiment, the middle portion of the front door plate is a transparent glass window.

In another aspect of the present invention, a handle is arranged at the upper end of the front door plate, and is located above the transparent glass window.

In another preferred embodiment, an illuminating light is mounted on the side wall of the lower fuel gas baking chamber.

In another preferred embodiment, side trim strips are respectively arranged on the two sides of the movable glass cover plate.

In another preferred embodiment, a front trim strip is arranged above the control panel. Compared with the prior art, the present invention has the following advantages:

According to the vehicle-mounted temperature-controllable oven of the present invention, a boiling or baking way can be chosen according to the type of the food. The upper portion of the oven is provided with a chimney cover by which the pollution to the food and air when baking food by using fuel gas can be reduced, and the control panel is provided with a temperature-control panel through which the baking temperature and baking time can be set and controlled, and the opening and closing of the gas path of the gas stove can be controlled, achieving a safe and convenient use. Function knobs are arranged on the control panel, which possess a safety-warning function, and are respectively provided with a bidirectional LED light (a red light and a blue light). When the fuel gas is turned off, the blue LED light is on, and when the fuel gas is turned on, the red LED light is on, achieving a safer use.

### BRIEF DESCRIPTION OF THE DRAWINGS

FIG. 1 is a structural diagram of the vehicle-mounted temperature-controllable oven;

FIG. 2 is an exploded view of the vehicle-mounted temperature-controllable oven;

FIG. 3 is a structural diagram of the fuel gas heating device of the vehicle-mounted temperature-controllable oven;

FIG. 4 is a front view of the temperature controller of the vehicle-mounted temperature-controllable oven.

In the Figures:

1—Oven Body, 2—Front Door Plate, 3—Movable Glass Cover Plate, 31—Auxiliary Cover Plate, 32—Main Cover Plate, 4—Glass Supporting Plate, 5—Chimney Trim Strip, 6—Chimney Cover, 7—Control Panel, 8—Temperature Control Panel, 9—Glass Window, 10—Handle, 11—Side Trim Strip, 12—Function Knob, 13—Fuel Gas Heating Device, 131—Fuel Gas Heater, 132—Gas Pipe, 133—Gas Solenoid Valve, 14—Working Platform, 14—Front Trim Strip, 16—Baking Rack, 17—Illuminating Light, 18—Fuel Gas Heating Apparatus, 19—Bearing Platform, 20—Bearing Rack, 21—Insulating Partition Plate

### DETAILED DESCRIPTION OF THE INVENTION

In order to make technical problems solved by the present invention, technical solutions and advantages clearer, drawings and detailed embodiments are combined hereinafter to elaborate the technical principles of the present invention.

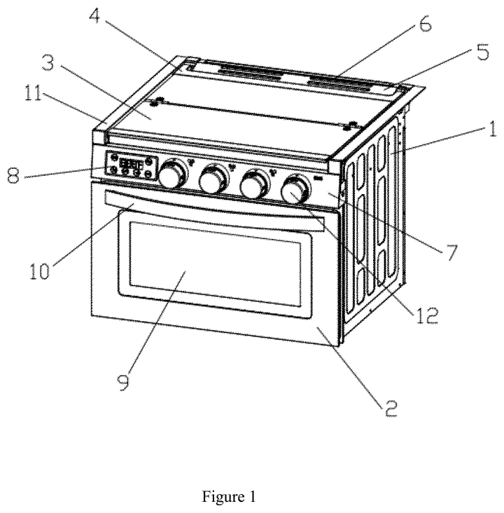

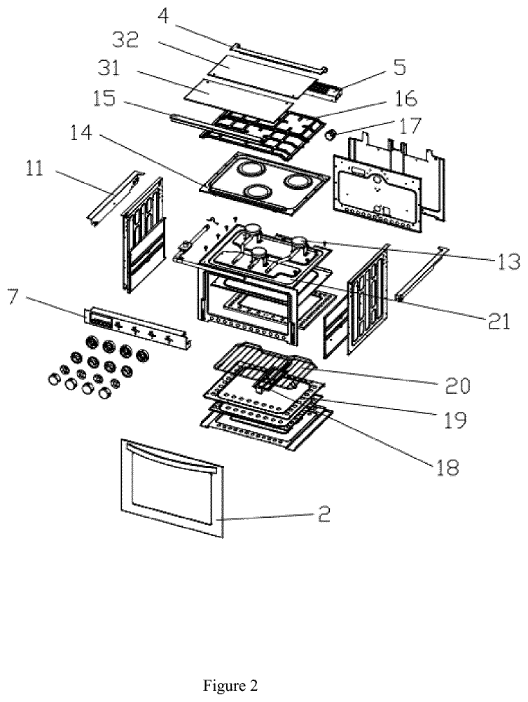

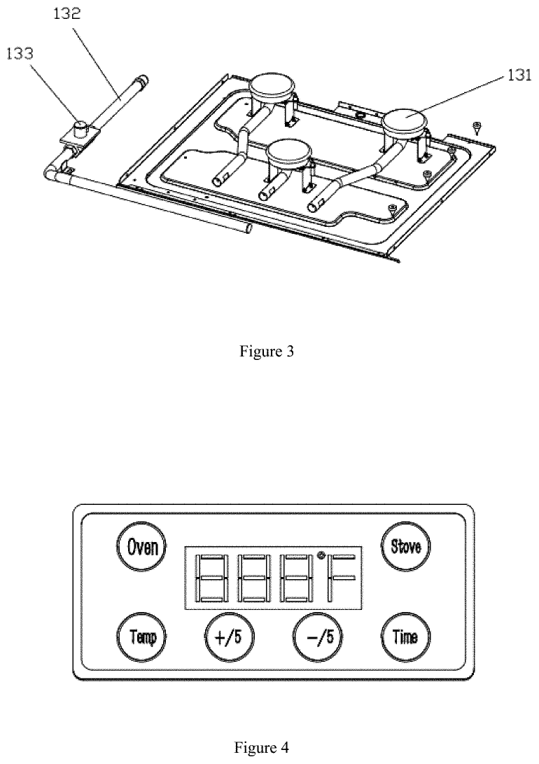

As shown in FIGS. 1-4, a vehicle-mounted temperature-controllable oven comprises an oven body 1 and an insulating partition plate 21, wherein the insulating partition plate 21 is made of an electrical insulating material, and is arranged inside the oven body 1 for dividing the oven body 1 into an upper fuel gas baking chamber and a lower fuel gas baking chamber.

The oven body 1 is provided with two door bodies, wherein one door body is arranged at the front end of the oven body 1. The said door body is a front door plate 2, which is hinged to the bottom of the oven body 1, and can be opened downwards. A transparent glass window 9 is arranged in the middle of the front door plate 2. When the front door plate 2 is closed, the baking state of the food in the oven body 1 can be observed through the transparent glass window 9. A handle 10 is arranged at the upper end of the front door plate 2, and is located above the transparent glass window 9. When there's a need to access the food, the front door plate 2 can be opened through the handle 10. The other door body is arranged at the top of the oven body 1, and the top door body is a movable glass cover plate 3 that can be opened upwards. The movable glass cover plate 3 further comprises a main cover plate 31 and an auxiliary cover plate 32. One end of the main cover plate 31 and one end of the auxiliary cover plate 32 are hinged with each other, and the movable glass cover plate 3 can be opened in half or full according to the requirement. The movable glass cover plate 3 is connected with a glass supporting plate 4 through a hinge. A chimney trim strip 5 is embedded in the groove of the rear end of the glass supporting plate 4, and a chimney cover 6 is arranged in the middle of the chimney trim strip 5. By means of the aforesaid design, the flue gas generated during the boiling or baking process can be effectively sucked, significantly reducing the pollution to the food and the air. Side trim strips 11 are respectively arranged on the two sides of the movable glass cover plate 3, and a front trim strip 15 is arranged above a control panel 7.

A fuel gas heating device 13, a working platform 14 and a baking rack 16 are arranged in the upper fuel gas baking chamber, wherein the upper portion of the fuel gas heating device 13 is covered by the working platform 14. The baking rack 16 is erected above the working platform 14 through a supporting frame. The fuel gas heating device 13 further comprises a fuel gas heater 131, a gas pipe 132 and a gas solenoid valve 133. The fuel gas heater 131 is connected with the gas pipe 132, and the gas solenoid valve 133 is installed on the gas pipe 132 for controlling the communication of the fuel gas. The fuel gas heater 131 is fixed on the insulating partition plate 21. There're three fuel gas heaters, which are distributed in a triangle-shape.

A fuel gas heating apparatus 18 is arranged inside the lower fuel gas baking chamber, and a bearing platform 19 and a bearing rack 20 are arranged between the fuel gas heating apparatus 18 and the insulating partition plate 21. The bearing platform 19 can be used for bearing all kinds of foods to be baked, and the bearing rack 20 is mainly used for bearing block-shaped foods. An illuminating light 17 is mounted on the side wall of the lower fuel gas baking chamber, which allows the baking state of the foods at different stages in the oven body 1 to be observed more clearly.

A control panel 7 is arranged above the front door plate 2, and four function knobs 12 and a temperature-control panel 8 are arranged on the control panel 7. The four function knobs 12 are used for respectively controlling the heat of the three fuel gas heaters 131 and the fuel gas heating apparatus 18. Meanwhile, the function knob 12 possesses a safety-warning function, and is provided with a bidirectional LED light (a red light and a blue light). A magnetic attraction switch is installed on the light panel. When the fuel gas is turned off, the blue LED light is on, and when the gas solenoid valve 133 is opened, the magnetic attraction switch on the LED light panel is magnetized, and the red LED light is on. Therefore, when the fuel gas is turned on, the red light is on, achieving a safer use. It prevents the user from forgetting to turn off the fuel gas so that accidents can be avoided.

Through the temperature-control panel 8, the baking time and baking temperature can be set, controlled and displayed, and the opening and closing of the gas path of the fuel gas oven can be controlled, which is safer and more convenient. The ignition is electronically controlled, wherein a pulse igniter is controlled through the circuit to achieve a quick ignition. Therefore, a quick use of the oven can be achieved. Meanwhile, the opening and closing of the gas path can be electronically controlled, and the gas solenoid valve 133 can be controlled through the circuit. When the gas solenoid valve 133 is electrified, the gas path is opened, and when the power is cut off, the gas path is automatically closed, thereby ensuring a safe use of the oven. A timer is installed on the temperature control panel 8, and the time can be set before baking according to the requirements of the foods. When the timer expires, the oven is automatically turned off, thus avoiding the risks. A temperature controller is further installed on the temperature-control panel 8, and the temperature can be fed back to the temperature controller on the temperature-control panel 8 through a temperature sensing probe arranged in the oven chamber. The temperature controller controls the heat amount of the fuel gas heating device in the oven chamber according to the temperature so that the temperature control function can be achieved.

During use, the power is turned on first, and the boiling or baking process is chosen according to the food type. When the food needs to be boiled, the movable glass cover plate 3 can be opened, and the utensil containing the food can be placed on the baking rack 16. When the power is turned on, the gas solenoid valve 133 is opened, thereby opening the gas path. At this point, the fuel gas heater 131 starts boiling the food, and when the boiling process is completed, the food can be taken out. When the power is turned off, the gas solenoid valve 133 is closed, thereby closing the gas path. Thus, the safe use of the oven can be ensured. When the food needs to be baked, the front door plate 2 is opened, and after the food is placed on the bearing platform 19 or the bearing rack 20, the front door plate 2 is closed. The baking time and baking temperature of the food is set through the temperature-control panel 8. After the baking switch is turned on, the fuel gas heating device starts to bake the food. The baking state of the food can be observed through the glass window 9. After the preset baking time is over, the baking process is completed, and the food can be taken out from the oven.

The above description is only the preferred embodiments of the present invention and does not limit the patent scope of the present invention, any equivalent structure or equivalent process modification used according to the contents of the specification and accompanying drawings in the present invention, no matter whether it is directly or indirectly used in any other related technical field, should be included within the protection scope of the present invention.

1. A vehicle-mounted temperature-controllable oven, comprising:
an oven body (1) and an insulating partition plate (21), wherein the insulating partition plate (21) is arranged inside the oven body (1) for dividing the oven body (1) into an upper fuel gas baking chamber and a lower fuel gas baking chamber, wherein a moveable glass cover plate (3) that can be opened upwards is arranged at the top of the oven body (1), wherein a front door plate (2) that can be opened downwards is arranged at the front end of the oven body (1), and is hinged with the bottom of the oven body (1), wherein a fuel gas heating device (13), a working platform (14) and a baking rack (16) are arranged in the upper fuel gas baking chamber, wherein the upper portion of the fuel gas heating device (13) is covered by the working platform (14), and the baking rack (16) is erected above the working platform (14) through a supporting frame, wherein a fuel gas heating apparatus (18) is arranged inside the lower fuel gas baking chamber, and a bearing rack (20) and a bearing platform (19) are respectively arranged above and underneath the fuel gas heating apparatus (18), wherein the movable glass cover plate (3) is connected with a glass supporting plate (4) through a hinge, wherein a chimney trim strip 5 is embedded in the groove of the rear end of the glass supporting plate (4), and a chimney cover (6) is arranged in the middle of the chimney trim strip (5), wherein a control panel (7) is arranged above the front door plate (2), and the control panel (7) is provided with function knobs (12) and a temperature-control panel (8) used for controlling the baking time and the baking temperature.

2. The vehicle-mounted temperature-controllable oven of claim 1, wherein the fuel gas heating device (13) comprises a fuel gas heater (131), a gas pipe (132) connected with the fuel gas heater (131), and a gas solenoid valve (133) installed on the gas pipe (132) for controlling the communication of the fuel gas.

3. The vehicle-mounted temperature-controllable oven of claim 2, wherein there're three fuel gas heaters (131), which are distributed in a triangle-shape.

4. The vehicle-mounted temperature-controllable oven of claim 3, wherein the fuel gas heater (131) is fixed on the insulating partition plate (21).

5. The vehicle-mounted temperature-controllable oven of claim 1, wherein the movable glass cover plate (3) comprises a main cover plate (31) and an auxiliary cover plate (32), wherein one end of the main cover plate (31) and one end of the auxiliary cover plate (32) are hinged with each other.

6. The vehicle-mounted temperature-controllable oven of claim 1, wherein the middle portion of the front door plate (2) is a transparent glass window (9).

7. The vehicle-mounted temperature-controllable oven of claim 6, wherein a handle (10) is arranged at the upper end of the front door plate (2), and is located above the transparent glass window (9).

8. The vehicle-mounted temperature-controllable oven of claim 1, an illuminating light (17) is mounted on the side wall of the lower fuel gas baking chamber.

9. The vehicle-mounted temperature-controllable oven of claim 1, wherein side trim strips (11) are respectively arranged on the two sides of the movable glass cover plate (3).

10. The vehicle-mounted temperature-controllable oven of claim 9, wherein a front trim strip (15) is arranged above the control panel (7).

11. The vehicle-mounted temperature-controllable oven of claim 2, wherein side trim strips (11) are respectively arranged on the two sides of the movable glass cover plate (3).

12. The vehicle-mounted temperature-controllable oven of claim 3, wherein side trim strips (11) are respectively arranged on the two sides of the movable glass cover plate (3).

13. The vehicle-mounted temperature-controllable oven of claim 4, wherein side trim strips (11) are respectively arranged on the two sides of the movable glass cover plate (3).

14. The vehicle-mounted temperature-controllable oven of claim 5, wherein side trim strips (11) are respectively arranged on the two sides of the movable glass cover plate (3).

15. The vehicle-mounted temperature-controllable oven of claim 6, wherein side trim strips (11) are respectively arranged on the two sides of the movable glass cover plate (3).

16. The vehicle-mounted temperature-controllable oven of claim 7, wherein side trim strips (11) are respectively arranged on the two sides of the movable glass cover plate (3).

17. The vehicle-mounted temperature-controllable oven of claim 8, wherein side trim strips (11) are respectively arranged on the two sides of the movable glass cover plate (3).
